(19) United States
(12) Patent Application Publication
(10) Pub. No.: US 2024/0088645 A1
(43) Pub. Date: Mar. 14, 2024

(54) Circuit Arrangement, Electrical Energy Store Having a Circuit Arrangement of this Type, and Use of Said Circuit Arranagement as an Energy Store

(71) Applicant: Inform GMBH, Griesheim (DE)

(72) Inventors: Christos Vellios, Bischofsheim (DE); Joachim Sauerborn, Waldems (DE)

(73) Assignee: Inform GMBH, Griesheim (DE)

(21) Appl. No.: 18/275,487

(22) PCT Filed: Jan. 28, 2022
(86) PCT No.: PCT/EP2022/052127

§ 371 Date: Aug. 2, 2023

(30) Foreign Application Priority Data
Feb. 2, 2021 (DE) 102021200924.7

(51) Int. Cl. H02H 7/16

(52) U.S. Cl. CPC H02H 7/16

(57) ABSTRACT

The present invention relates to a circuit arrangement (1) having at least one supercapacitor (3) and at least one bypass circuit (9, 9′) connected in parallel to the supercapacitor (3), wherein at least one bypass circuit (9, 9′) comprises at least two bypass transistors (17) operating as switching elements, connected in parallel to the supercapacitor (3) and a transverse regulator (27) connected in parallel to the supercapacitor (3), where the switching threshold of transverse regulator (27) defines the switching point for the two or more bypass transistors (17) connected in parallel.

### INTRODUCTION

The subject invention relates to a circuit assembly having at least one supercapacitor and at least one bypass circuit, an electrical energy storage device having a circuit assembly, and the use of a circuit assembly as an energy storage device.

The energy can be stored, among other things, by chemical conversion (e.g., in the case of accumulators) or by physical processes (e.g., in the case of capacitors).

Capacitors can be differentiated according to their design. For example, there are ceramic capacitors, plastic film capacitors, metal paper capacitors and electrolytic capacitors. These types of capacitors usually have a capacitance in the range of Picofarad (pF) to about 1 Farad.

A special type of capacitors are so-called supercapacitors. Supercapacitors can have a capacitance in the range of Kilofarads or more. The capacitance of supercapacitors results from two different technical effects and can therefore be divided into double-layer and pseudo-capacitance. While the double-layer capacitance is based on charge separation, the pseudo-capacitance is the result of redox reactions. In operation, the double-layer capacitance and pseudo-capacitance add up to the total capacitance of the supercapacitor.

A special feature of supercapacitors is a low nominal voltage of usually 2.7 V compared to conventional capacitors. At the same time, supercapacitors are extremely sensitive to higher voltages. Even a small exceedance of the nominal voltage during the charging process can lead to permanent damage to the supercapacitor. If supercapacitors are integrated into electronic circuits, it therefore makes sense to protect them from higher voltages.

Since a voltage higher than 2.7 V is desired in many applications, supercapacitors are often connected in series, adding up the nominal voltages. However, due to the series connection, it can happen during the charging process that the individual supercapacitors are charged at different speeds. This is because of manufacturing tolerances, due to which nominally identical supercapacitors have different actual capacitances. The resulting different charging behavior can cause individual supercapacitors to exceed the nominal voltage and be permanently damaged.

To avoid damage to supercapacitors connected in series, WO 2018/237320 A1 proposes a balancing circuit in which each supercapacitor is assigned a bypass circuit. The bypass circuits are connected to a bus system and, when activated, provide charge balancing between the supercapacitors connected in series. Activation is carried out via a clock. The circuit is complex due to the use of a bus system and the clock generator. In addition, the clock generator only causes periodic and not permanent charge balancing. Thus, there is only temporary protection for the capacitors.

EP 1 274 105 B1 also proposes a bypass circuit for supercapacitors. The bypass circuit includes a transistor, a low-pass filter and a detector unit that generates a logic signal that is delivered to a charging device to charge the supercapacitor, thereby controlling the charging current by means of which the supercapacitor is charged. Due to the detector unit and the control of the charging device, this bypass circuit is also very complex.

DE 600 23 772 T2 discloses a circuit arrangement with a double-layer capacitor and a shunt regulator connected in parallel to the double-layer capacitor, as well as an NPN transistor connected in parallel to the double-layer capacitor. The terminal of the shunt regulator is connected to the base of the NPN transistor.

US 2020/0044459 A1 discloses a device and method designed to protect the batteries of a battery pack from overcharging.

### DESCRIPTION OF INVENTION

It was therefore the object of the invention to provide a circuit assembly that provides better and inexpensive protection for supercapacitors against exceeding the rated voltage.

This problem is solved by a circuit assembly disclosed herein.

The circuit arrangement according to the invention comprises at least one supercapacitor and at least one bypass circuit connected in parallel to the supercapacitor. The at least one bypass circuit comprises at least two bypass transistors operating as switching elements, each connected in parallel to the supercapacitor, and a transverse regulator connected in parallel to the supercapacitor, whose switching threshold defines the switching point for the bypass transistor.

In the invention, a transverse regulator is used to trigger the protective function—the surge protector—for the supercapacitor. A transverse regulator can generally be understood to be a component that is connected in parallel to the supercapacitor and, at least in an active state, always absorbs so much current that the voltage at the supercapacitor is kept constant. In the bypass circuit, the transverse regulator acts as a threshold switch. A threshold switch is generally an electronic or electrical component that combines the function of a sensor with a switching function. The switching process is triggered when the physical quantity “measured” by the sensor exceeds a preset limit value (the threshold value). In the present case, the measured quantity is a quantity of the circuit arrangement, namely the capacitor voltage applied to the supercapacitor. The transverse regulator is preferentially switchable and has a control input for this purpose. For example, a Zener diode (not switchable), also known as a Z-diode, or a TL431 (switchable) can be used as a transverse regulator. The transverse regulator can therefore also be referred to as a parallel regulator, shunt regulator, zener diode or threshold value switch.

The switching threshold is an intrinsic quantity of the transverse regulator. If the transverse regulator has a control input, the switching threshold must be reached at the control input for the transverse regulator to switch. For a TL431, the switching threshold is 1.5 V to 2.5 V, for a Zener diode, the breakdown voltage corresponds to the switching threshold.

During the charging process, the supercapacitor is first charged by a charging current as usual. The bypass circuit is in a passive state if the switching threshold of the transverse regulator is not reached. When the switching threshold is reached, at least two bypass transistors are controlled by the transverse regulator. The bypass circuit is then in an active state. The bypass circuit conducts current around the supercapacitor in this state. This current does not charge the supercapacitor any further, so there is no overvoltage, and the supercapacitor is protected.

The amplification effect of transistors is not binary, but follows a characteristic curve and depends on the level of the voltage at the capacitor (base-emitter voltage) and/or a control signal. A higher base-emitter voltage increases the gain, i.e., the transistor is further “driven”. With a low control signal, the amplification effect of a transistor is lower. Simple capacitors have higher nominal voltages compared to supercapacitors. These higher voltages are then also available to drive transistors in a bypass circuit. As a result of the higher voltages, the transistors of the bypass circuit control more strongly and immediately conduct a higher current around the capacitor, thus protecting it very effectively. In the case of simple capacitors, bypass circuits thus achieve a sufficient bypass effect.

This is not necessarily the case with supercapacitors due to their low nominal voltage. It has been shown that the low nominal voltage of supercapacitors means that the control signal does not switch the transistors optimally and thus only a reduced current line, i.e., no optimal protection for the supercapacitors, is given.

By arranging at least two bypass circuits in parallel to the supercapacitor, more current can be conducted around the supercapacitor overall. The bypass circuits are independent of each other. Therefore, different switching points can be provided for the respective controlled bypass transistor. In this way, for example, the protection of the supercapacitor can also be switched on in several stages depending on the applied voltage.

A further improvement in the protection effect is achieved by comprising two bypass transistors operating as switching elements, each connected in parallel to the supercapacitor, where the switching threshold of the transverse regulator defines the switching point for the two bypass transistors connected in parallel. The bypass transistors are preferably nominally identical. In this case, the two bypass transistors are connected together and allow a higher current to be passed around the supercapacitor.

As described, supercapacitors are subject to manufacturing tolerances (manufacturing tolerances). If several supercapacitors are connected in series in a circuit, the individual supercapacitors are charged at different speeds. This effect increases with the difference in the actual capacitance of each capacitor. The inventors have realized that this effect can be reduced by connecting several capacitors in parallel, which better protects the individual supercapacitors. In the case of advantageous further training, at least two supercapacitors connected in parallel are therefore provided, which together form a supercapacitor group. In other words, several supercapacitors are connected in parallel and in parallel the two bypass circuits or a single bypass circuit with two bypass transistors are provided. The parallel connection of several capacitors statistically leads to the fact that strong deviations of the supercapacitor group from their nominal capacitance become less likely. Particularly preferable are the supercapacitors connected in parallel nominally identical in construction. Identical components have the same tolerance limits, which makes the statistical effect particularly effective.

Preferably, several supercapacitors or supercapacitor groups are connected in series, wherein each of the several supercapacitors or each of the several supercapacitor groups is assigned at least one bypass circuit connected in parallel according to the above description. As a result, the circuit assembly has a larger total nominal voltage, which results in more application possibilities for the circuit assembly.

The bypass transistor is preferably a bipolar transistor. A MOSFET (metal-oxide-semiconductor field-effect transistor) can also be used. In any case, it is preferred that the bypass transistor delivers a sufficiently high current, especially>2 A, between the base and the emitter even at low voltages, especially at <2.7 V. In this way, the bypass transistor provides a good protection function for the supercapacitor.

At which capacitor voltage applied to the supercapacitor or supercapacitor group the transverse regulator switches, i.e., reaches its switching threshold, is preferably defined by a voltage divider connected parallel to the supercapacitor, the node of which is connected to the control input of the transverse regulator of at least one bypass circuit. In this way, the bypass circuit can be adapted to the supercapacitor or supercapacitor group. The voltage divider preferably comprises at least two resistors connected in series, between which the node lies, and which influence the node potential. Particularly preferred are the voltage dividers of the two bypass circuits, each connected in parallel to the same supercapacitor, and thus their node potentials are different. In this way, the two bypass circuits are switched on in a cascade at different times, namely at different capacitor voltages. As a result, the charging current is gradually lowered when approaching the nominal voltage of the supercapacitor(s) and the risk of “overshooting” the charging voltage is reduced.

The voltage divider of at least one bypass circuit preferably includes a variable resistor arrangement by means of which the node potential can be selected. In other words, the variable resistor arrangement can be used to select the capacitor voltage at which the transverse regulator reaches its switching threshold. In this way, different bypass circuits, for example within a bypass cascade or for different supercapacitors, can be realized with the same components, which can reduce production costs. The node potential is then influenced depending on which switching point is desired or what capacitance the supercapacitor connected in parallel has.

The variable resistor arrangement preferentially has several parallel substrings, each with a different electrical resistance, and comprises a means of selection, whereby exactly one substring can be selected as a conductive substring by means of the selector or several substrings can be selected as conductive substrings. The selection tool makes it easy to select between the sub strings exactly the sub string(s) that is the right one(s) for the supercapacitor to be used. The selection can be made by a fixed contact, for example by soldering, or a variable contacting, for example by means of a changeover switch. If two bypass circuits are used for a supercapacitor or a supercapacitor group and their transverse regulators are to switch at different capacitor voltages, a first substring can be selected in one bypass circuit and a second substring in the other bypass circuit when using identical components. As a result, the node potentials of the two voltage dividers are always different and, as a result, the switching times of the transverse regulators also deviate from each other. As a result, the different switching timing of the two bypass circuits can be realized in a simple way.

As an alternative to a plurality of substrings, the variable resistor arrangement preferably includes a potentiometer. A potentiometer allows a continuous adjustment of the resistance and thus ultimately the switching time. A circuit arrangement with potentiometer can thus be adapted more flexibly to the needs.

At least one bypass circuit preferably includes an evaluation transistor for controlling an evaluation unit, whereby the switching threshold of the transverse regulator defines the switching point for the evaluation transistor. The evaluation transistor makes it possible to determine by means of an evaluation unit whether the transverse regulator has switched, and the bypass circuit is active. The output of the evaluation transistor is connected to a control input of the evaluation unit. The circuit arrangement can also include the evaluation unit. Preferably, a common or central evaluation unit is provided for several bypass circuits of the circuit arrangement. If, for example, different switching times for the bypass transistors are defined in two bypass circuits connected in parallel, the evaluation unit can be used to determine which of the two bypass circuits is switched on and when. This is another advantage of the different node potentials in several bypasses. Several evaluation transistors allow a more precise (step-by-step) control of the state of the circuit/supercapacitor, for example, to determine a proper charging process up to the desired capacitor voltage or an aging process or other defect. Therefore, in a circuit arrangement with at least two bypass circuits, a central evaluation unit is particularly preferred, whereby an output of each evaluation transistor of at least two bypass circuits is connected to an input of the evaluation unit.

It may be desired to interrupt the charging process. This is the case, for example, when all supercapacitors in the circuit assembly are fully charged. As described, this state can be determined using the evaluation transistors and the evaluation unit. The circuit arrangement preferably includes a switching device which is set up to be able to disconnect and close the connection between a terminal for a power source and the supercapacitor. The switching element is preferably a relay.

Preferably, a resistor to the bypass transistor is connected in series and the resistor and the bypass transistor are connected together in parallel to the supercapacitor. This prevents a short circuit from occurring in the event of activation of the bypass circuit.

The transverse regulator preferentially defines the switching point for the bypass transistor by connecting an output of the transverse regulator to a control input of each bypass transistor. Particularly preferably, a resistor is arranged between the output (anode connection) of the transverse regulator and the input of each bypass transistor. The use of a resistor between the transverse regulator and the bypass transistor serves to compensate for tolerances. The resistors ensure that the actual switching times of the bypass transistors, which always deviate due to tolerance, are not too far apart.

It has been shown that it can be useful to protect supercapacitors even during discharge. In particular, a discharge below a predetermined value is generally undesirable. Therefore, preferably, the circuit assembly includes undervoltage protection. The undervoltage protection preferably includes a control unit, in particular a microcontroller. The control unit is set up to detect the capacitor voltage, to determine an imminent undervoltage on the basis of a specified limit value and then to interrupt the discharge process. Particularly preferably, the control unit is connected to a switching element, whereby the switching element is located between the consumer and the supercapacitor. The control unit is set up to drive the switching element when the capacitor voltage drops below the specified limit.

According to one embodiment of the invention, one and the same switching device is arranged between a common connection of the power source and the load, and the supercapacitor is sufficient to disconnect the capacitor in both undervoltage and overvoltage. In other embodiments, two switching elements may also be provided. In this case, there is a switching element between the current source and the supercapacitor and the other switching element between the consumer and the supercapacitor. The switching elements can then be controlled by the control unit when a limit value for undervoltage or overvoltage is reached. Alternatively, a changeover relay can be used, with which the supercapacitor can be connected either to the power source or to the consumer.

As mentioned, the power source and the consumer can be directly connected to each other, whereby the circuit assembly is then connected to the power source and the consumer on a common connection. Such interconnection is conceivable, for example, in a photovoltaic system (power source) to which an electric vehicle with a local energy storage system (consumer) is connected. The circuit arrangement then stores any surplus energy that may be present and releases energy when the consumer needs more than the photovoltaic system delivers.

In addition to the switching device, a (high-power) rectifier and/or diodes can be used in both cases at the connection between the circuit assembly and the current source or circuit assembly and the load. If the current source and load can be connected separately from each other to the circuit arrangement, a diode is preferably placed between the current source and the supercapacitor and/or a diode between the consumer and the supercapacitor, whereby the diodes only allow the desired current direction, i.e. from the current source to the supercapacitor and from the supercapacitor to the consumer. Diodes and/or (high-power) rectifiers can also be used in parallel with the switching gate. If, for example, electric motors are operated directly with the stored energy from the circuit arrangement, the use of a “hard” switching element, such as a relay, is problematic: In this case, a high current suddenly flows when the switching organ is switched on, which is disadvantageous. To mitigate this, a diode or a high-power rectifier can be connected in parallel to the switching element in order to initially allow only a lower current flow, whereby the electric motor then only receives the maximum possible current flow when the switching element is switched on. Such a setup is particularly conceivable if the circuit arrangement is used as an intermediate storage device, for example between a fuel cell and electric motors of a vehicle drive. A diode connected in parallel, or a (high-power) rectifier connected in parallel can optionally also be connected in series with another switching element in order to be able to prevent any current flow to the consumer.

If several supercapacitors or supercapacitor groups are connected in series, the capacitor voltage may be measured over the entire supercapacitor group, considering a safety margin in addition to the sum of the nominal voltages of the individual supercapacitors in the specified limit value of the undervoltage. Preferably, however, the control unit is set up to detect the capacitor voltage at each supercapacitor or supercapacitor group and compare it with the limit value. The connection to the load is disconnected when one of the supercapacitors or one of the supercapacitor groups falls below the limit.

The problem of the invention is also solved by an electrical energy storage device having a housing and a circuit arrangement arranged in the housing according to the above description. The housing protects the circuit assembly and especially the supercapacitors from external influences. As a result, the circuit arrangement can be set up in the private sector, for example, and connected to a photovoltaic system and charged by it. The circuit arrangement can also be used in a vehicle, in particular as intermediate storage in vehicles with alternative drives, e.g., in electric vehicles and in vehicles powered by hydrogen, natural gas or liquefied petroleum gas. For example, the circuit arrangement in a fuel cell vehicle can be used as an intermediate storage between the fuel cell and drive motors or as a primary energy source for an electric vehicle (e-vehicle). The circuit arrangement can also be used as an intermediate storage device in an electric vehicle charging station. Another possible application concerns wind turbines. Currently, wind turbines are shut down (taken out of the wind) when there is enough energy in the power grid. During this time, they are prevented from feeding energy into the grid, which reduces their efficiency. The circuit arrangement can be used here as a buffer, which is always charged when the power grid cannot absorb energy. When the power grid is ready to resume, the energy stored in the buffer can be fed into the grid. The circuit arrangement can also be used as a mobile storage device. For example, it can be arranged on a (Euro) pallet and loaded into a vehicle (e.g., a van) in this way. The vehicle can then be used to charge other vehicles (broken-down e-vehicles, e-scooters, etc.). The circuit arrangement can also be used as a mobile storage device in an electric vehicle by being the primary source there, but replaceable. A corresponding use of the circuit arrangement is therefore also the subject of the invention. Due to the high possible charge and discharge currents of supercapacitors, their use can shorten the charging times of electric vehicles without having to increase the line capacities to the charging stations, especially if the charging station or charger is equipped with the circuit arrangement according to the invention, which benefits this application. The capacitors can then be charged over a longer period of time during which no consumer is connected.

### DESCRIPTION OF FIGURES

The invention is illustrated and explained below by means of the figures as follows:

FIG. 1 is a schematic of a circuit assembly according to a first embodiment,

FIG. 2 is a schematic of a circuit assembly according to a second embodiment, and

FIG. 3 shows a schematic of a circuit assembly according to a third embodiment.

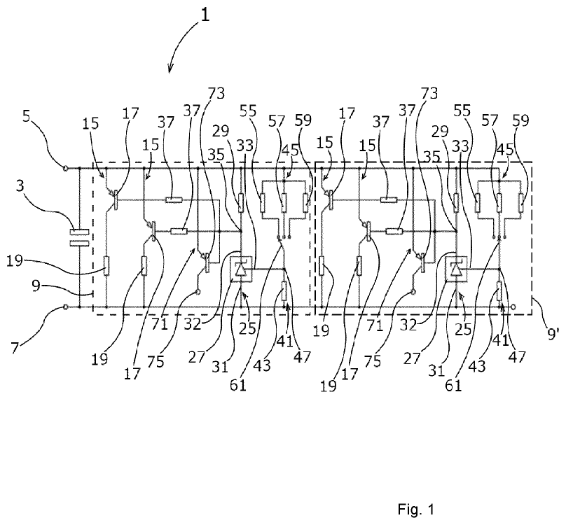

The circuit assembly 1 shown in FIG. 1 includes a supercapacitor 3 as well as an anode terminal 5 and a cathode terminal 7 to which a power source (not shown) and a load (not shown) can be connected. If a power source is connected, the supercapacitors 3 are charged.

In parallel with each of the supercapacitors 3, two bypass circuits 9.9′ are provided. The bypass circuits 9, 9′ are identical in terms of the components used, which is why only one is described in detail below.

The bypass circuit 9, 9′ comprises a plurality of strings, each of which is connected in parallel to supercapacitor 3: two bypass strings 15, a regulator string 25, and a voltage divider string. The strands are explained in more detail below:

The bypass string 15 comprises the load section of a bypass transistor 17, wherein the load section is connected in series with a first resistor 19. The bypass circuit 9, 9′ comprises two bypass strands 15, each with a bypass transistor 17. The bypass strings 15 are each connected in parallel to the supercapacitor 3. The bypass transistor 17 is a pnp bipolar transistor.

The regulator string 25 comprises the load section of a transverse regulator 27, wherein the load section is connected in series with a second resistor 29. The transverse regulator 27 is a TL431.

It is a controllable transverse regulator 27 with three terminals, an anode terminal 32, a cathode terminal 31 and a reference terminal 33. The load range runs between the anode terminal 32 and the cathode terminal 31.

Between the transverse regulator 27 and the second resistor 29 is a node 35 connected to the base of both bypass transistors 17. Between the node 35 and the base, a third resistor 37 is arranged for tolerance compensation. If there is a voltage below its switching threshold between the reference terminal 33 and the anode of the transverse regulator 27, the transverse regulator 27 locks. The basis of both bypass transistors 17 then lies on the anode potential. If the switching threshold of the transverse regulator 27 is reached at its reference terminal 33, the transverse regulator 27 conducts and the system voltage drops across the second resistor 29. The basis of the bypass transistors 17 is therefore drawn to the potential of the cathode, making the bypass transistors 17 conductive. In this way, the switching threshold of the transverse regulator 27 defines the switching point for the bypass transistors 17. After switching the bypass transistors 17, part of the charging current flows past the supercapacitor 3 through the bypass transistor 17 and in this way no longer charges the supercapacitor 3. The supercapacitor 3 is protected against overvoltage in this way.

The voltage divider string has a voltage divider 41. The voltage divider 41 comprises a single fourth resistor 43 connected in series with a variable resistor assembly 45. Between the fourth resistor 43 and the variable resistor assembly 45, a node 47 is arranged, which is connected to the reference port 33, i.e., the control input, of the transverse regulator 27. In this way, the voltage divider 41 defines the capacitor voltage at which the transverse regulator 27 reaches its switching threshold and switches.

The variable resistor arrangement 45 comprises several substrings connected in parallel, each with a resistor 55, 57, 59 and a selector 61. The resistors 55, 57, 59 are of different sizes. By means of the selection agent 61, exactly one substrand can be selected as the conductive substring. In this way, the voltage divider 41 can be adapted to the supercapacitor 3 to be protected. The choice of the conductive substring affects the capacitor voltage at which the transverse regulator 27 reaches its switching threshold because the node potential at node 47 changes depending on which substring is selected as the conductive substring.

The two bypass circuits 9, 9′, which are connected in parallel to the same supercapacitor 3, have, as mentioned, the same components, which are interconnected in the same way. However, the variable resistor arrays 45 of the two bypass circuits 9, 9′ are set differently. In the embodiment shown, the first substring with the resistor 55 is selected for one bypass circuit 9 and the second substring with the resistor 57 is selected as the conductive substring for the second bypass circuit 9′. As a result, the transverse regulators 27 of the bypass circuits 9 reach their switching threshold at different capacitor voltages and control their respective bypass transistors 17 at different times.

The circuit arrangement 1 further comprises an evaluation string 71, which comprises an evaluation transistor 73 for controlling an evaluation unit (not shown) and is connected to the anode terminal 5 on the one hand and to an evaluation output 75 on the other. The evaluation transistor 73 is also controlled by the transverse regulator 27 as soon as it reaches its switching threshold. In this way, the switching threshold of the transverse regulator 27 defines the switching point for the evaluation transistor 73. The evaluation unit can be connected to the evaluation output 75. In this way, the evaluation unit can be used to determine whether the respective bypass circuit is 9, 9′ active or passive.

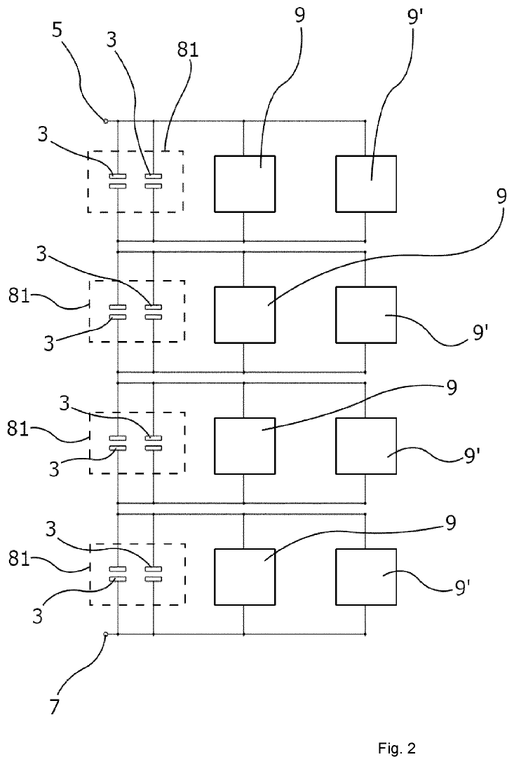

The circuit arrangement 1 according to FIG. 2 has four supercapacitor groups 81 connected in series, each with two supercapacitors 3 connected in parallel. Each supercapacitor group 81 is protected from overvoltage by two bypass circuits 9, 9′ connected in parallel to the associated supercapacitor group 81. The bypass circuits 9, 9′ are identical to those of the embodiment according to FIG. 1 and are shown here only schematically.

In the embodiment shown, all supercapacitors 3 are nominally identical. This makes it less likely that supercapacitor groups 81 will deviate greatly from their nominal capacitance, which in this case corresponds to twice the nominal capacitance of a single supercapacitor 3.

By connecting the supercapacitor groups 81 in series, the nominal voltages of the individual supercapacitors 3 add up to a total nominal voltage of the circuit assembly 1. A single supercapacitor 3 in this embodiment has a nominal voltage of 2.7 V, so the circuit assembly 1 has a total nominal voltage of 4·2.7 V=10.8 V.

In other embodiments, the number of supercapacitors connected in series 3 or supercapacitor groups 81 may be different. Similarly, in other embodiments, the supercapacitor groups 81 may comprise more than two supercapacitors 3 connected in parallel.

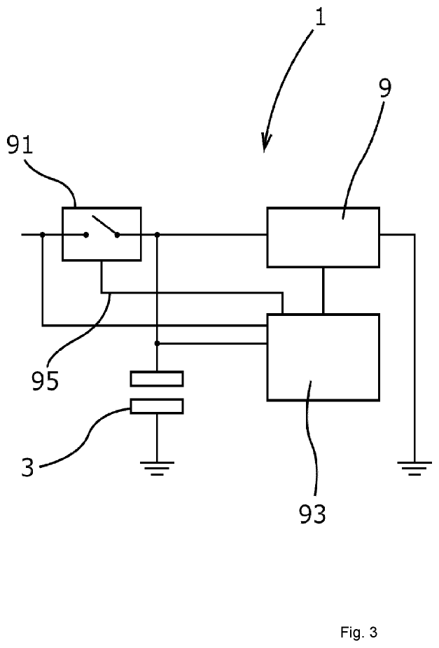

The circuit assembly 1 shown in FIG. 3 includes a supercapacitor 3 that is protected from overvoltage by a bypass circuit 9.

The circuit assembly 1 further comprises a relay 91 by means of which the supercapacitor 3 is connected to a load (not shown) and a power source (not shown). The consumer and the power source are thus located in front of relay 91 and the supercapacitor 3 is located behind relay 91. A microcontroller 93 detects the voltage upstream and downstream of the relay 91. In addition, the microcontroller 93 is connected to the bypass circuit 9 and receives the signal of the evaluation transistor 73 as an input signal. In the case of several supercapacitors 3 connected in series, the microcontroller 93 detects, on the one hand, the total voltage across all supercapacitors 3 and, by means of the evaluation transistors 73, the voltage applied across the individual supercapacitors 3 (or supercapacitor groups 81).

If the microcontroller 93 detects that the voltage behind the relay 91 exceeds a specified upper limit, i.e., an overvoltage is imminent, or falls below a specified lower limit, i.e., an undervoltage is imminent, it opens the relay 91 by means of a control line 95 and thus protects the supercapacitor 3.

Since the microcontroller 93 also detects the voltage upstream of the relay 91, it can detect the voltage state on the side of the load and the current source even when relay 91 is open and, depending on this, close the relay 91 again when the respective limit value is again undershot or exceeded, or otherwise leave it open.

### REFERENCES

1 Circuit Arrangement
3 Super Capacitor
5 Anode Connection
7 Cathode Connection
9, 9′ Bypass Circuit
15 Bypass Strand
17 Bypass Transistor
19 First Resistor
25 Regulation Strand
27 Transverse Regulator
29 Second Resistor
31 Cathode Connection
32 Anode Connection
33 Reference Connection
35 Nodes
37 Third Resistor
41 Voltage Dividers
43 Fourth Resistor
45 Variable Resistor Arrangement
47 Nodes
55 Resistor
57 Resistor
59 Resistor
61 Selection Device
71 Evaluation Strand
73 Evaluation Transistor
75 Evaluation Out
81 Supercapacitor Group
91 Relay
93 Microcontrollers
95 Control line

1. A circuit arrangement comprising least one supercapacitor and at least one bypass circuit connected in parallel to the supercapacitor, wherein at least one bypass circuit (9, 9′) comprises at least two bypass transistors (17) operating as switching elements, each connected in parallel to the supercapacitor (3), and a transverse regulator (27) connected in parallel to the supercapacitor (3), the switching threshold of which is the switching point for the at least two bypass transistors (17) connected in parallel.

2. The circuit arrangement of claim 1 wherein at least two supercapacitors (3) connected in parallel are provided, which together form a supercapacitor group (81).

3. The circuit arrangement of claim 2 wherein the supercapacitors connected in parallel (3) are nominally identical.

4. The circuit arrangement of claim 3 wherein the several supercapacitors (3) or several supercapacitor groups (81) are connected in series, wherein each of the several supercapacitors (3) or each of the several supercapacitor groups (81) is assigned at least one bypass circuit connected in parallel (9, 9′) according to one of the above claims.

5. The circuit arrangement of claim 4 wherein the bypass transistor (17) of at least one bypass circuit (9, 9′) is a bipolar transistor or a MOSFET.

6. The circuit arrangement of claim 5 wherein at least one bypass circuit (9, 9′) comprises a voltage divider (41) connected in parallel to the supercapacitor (3), the node of which (47) is connected to a control input of the transverse regulator (27) of at least one bypass circuit (9, 9′), wherein is defined by the voltage divider (41) at which the supercapacitor (3) is applied capacitor voltage of the transverse regulator (27) reaches its switching threshold.

7. The circuit arrangement of claim 6 wherein at least two bypass circuits (9, 9′) connected in parallel to the supercapacitor (3) or to the supercapacitor group (81) are provided.

8. The circuit arrangement of claim 7 wherein the voltage dividers (41) of the two bypass circuits (9, 9′), each connected in parallel to the same supercapacitor (3), are different.

9. The circuit arrangement of claim 8 wherein the voltage divider (41) of at least one bypass circuit (9, 9′) comprises a variable resistor assembly (45) by means of which the node potential can be selected.

10. The circuit arrangement of claim 9 wherein the variable resistor assembly (45) has several parallel substrings, each having a different electrical resistance (55, 57, 59) and comprising a selector (61), wherein by means of the selector (61) exactly one substrand can be selected as the conductive substrand or several substrings can be selected as conductive substrings.

11. The circuit arrangement of claim 10 wherein the variable resistor assembly (45) comprises a potentiometer.

12. The circuit arrangement of claim 11 wherein at least one bypass circuit (9, 9′) comprises an evaluation transistor (73) for driving an evaluation unit, wherein the switching threshold of the transverse regulator (27) defines the switching point for the evaluation transistor (73).

13. The circuit arrangement of claim 12 further comprising a central evaluation unit, wherein one output of each evaluation transistor (73) of at least two bypass circuits (9, 9′) is connected to an input of the evaluation unit.

14. The circuit arrangement of claim 13 further comprising a first resistor (19) connected in series to the bypass transistor (17) and that the first resistor (19) and the bypass transistor (17) are connected together in parallel to the supercapacitor (3).

15. The circuit arrangement of claim 14 wherein an output of the transverse regulator (27) is connected to a control input of each bypass transistor (17), wherein a third resistor (37) is arranged between the output of the transverse regulator (27) and the input of each bypass transistor (17).
